(19) United States
(12) Patent Application Publication
(10) Pub. No.: US 2011/0019242 A1
(43) Pub. Date: Jan. 27, 2011

(54) IMAGE PROCESSING SYSTEM, IMAGE PROCESSING APPARATUS, IMAGE DATA TRANSFER METHOD AND RECORDING MEDIUM

(75) Inventors: Hiroki Tajima, Hyogo-ken (JP); Kazumi Sawayanagi, Hyogo-ken (JP); Toshihiko Otake, Osaka-fu (JP); Hideyuki Matsuda, Osaka-fu (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., TOKYO (JP)

(21) Appl. No.: 12/934,532

(22) PCT Filed: Sep. 10, 2009
(86) PCT No.: PCT/JP2009/065869

§ 371 Date: Sep. 24, 2010

(30) Foreign Application Priority Data
Sep. 19, 2008 (JP) 2008-241817

(51) Int. Cl. H04N 1/32; H04N 1/40; G06F 3/041

(52) U.S. Cl. 358/442; 358/448; 345/173

(57) ABSTRACT

An image processing system and others capable of allowing users to store data in a preferable destination folder among destination folders that are not limited, without requiring manual entry of a path to specify a destination folder, are provided. In a mode to transfer image data to an information processing apparatus, an image processing apparatus requests the information processing apparatus to allow to obtain screen data to reproduce a screen displayed on a display of the information processing apparatus. In response to the request, the information processing apparatus transmits the screen data to the image processing apparatus. And the image processing apparatus displays on a display thereof, a remote screen that is the information processing apparatus's screen reproduced based on the screen data. When a position over the remote screen is specified by a user, the image processing apparatus determines the specified position and transmits position data and image data to the information processing apparatus. The information processing apparatus calculates a position over the screen, corresponding to the position indicated by the position data received from the image processing apparatus, and stores the image data into a destination that is determined based on what is displayed in the calculated position over the screen.

### FIELD OF THE INVENTION

The present invention relates to an image processing system in which an image processing apparatus and an information processing apparatus consisting of a personal computer are interconnected via a network, an image processing apparatus such as an image forming apparatus capable of reading documents, an image data transfer method, and a computer readable recording medium having an image data transfer program recorded therein to make a computer execute processing.

### BACKGROUND TECHNOLOGY

Some of the multifunctional digital image forming apparatuses (MFP: Multi Function Peripherals) collectively having multiple functions such as the copy function, the print function, the scan function and the data transmission function, further have the data transfer function that is so-called “Scan to SMB (Server Message Block)” and “Scan to FTP (File Transfer Protocol)”. This is a data transfer function to transfer image data read out from a document by a document reader, to an image processing apparatus consisting of a personal computer (hereinafter, also will be referred to as “PC”).

In order to transfer image data read out from a document, by using such a data transfer function, a user has to specify a destination folder by operating an image forming apparatus.

As disclosed in the Japanese Unexamined Laid-open Patent Publication No. H05-119955, there is a technology to allow to remotely and mutually operate a screen shared with terminals, not depending on hardware/software configurations employed in the respective terminals.

### SUMMARY OF THE INVENTION

### Problem to Be Solved by the Invention

However, in conventional practices, available destination folders to transfer image data by using the data transfer function are limited to those set in advance as shared folders by operating the PC. Thus, it has been disadvantageous that the destinations for image data are limited.

Furthermore, if no destination folders are preliminarily registered in the image forming apparatus, manual entry of a path to specify a destination folder is required. Also, it has been disadvantageous that such a manual operation is troublesome.

And furthermore, available destination folders are limited. Thus, in order to store image data in a preferable folder, a user has to move the image data to his/her preferable folder after transferring the image data. Such a manual operation is also troublesome.

The Japanese Unexamined Laid-open Patent Publication No. H05-119955 mentioned above does not bring a solution against the troubles that occur when image data scanned by the image forming apparatus is transferred to the information processing apparatus as described above.

It is an object of the present invention to provide an image processing system with a high usability and a capability of allowing users to store image data in a preferable destination folder among those not limited to a certain range, without requiring manual entry of a path to specify a destination folder.

It is another object of the present invention to provide an image processing apparatus preferably employed in the image processing system above.

It is yet another object of the present invention to provide an image data transfer method implemented in the image processing system above.

It is still yet another object of the present invention to provide a computer readable recording medium having a program recorded therein to make a computer of the image processing apparatus implement the image data transfer method.

### Means for Solving Problem

According to a first aspect of the present invention, an image processing system comprises an image processing apparatus and an information processing apparatus consisting of a personal computer, interconnected via a network, wherein: the image processing apparatus comprises:
a reader that reads a document;
a data requester that requests the information processing apparatus to allow to obtain screen data to reproduce a screen displayed on a display of the information processing apparatus, in a mode to transfer image data read out from the document, to the information processing apparatus;
a display that displays on itself, a remote screen that is the image processing apparatus's screen reproduced based on the screen data that is transmitted by the information processing apparatus in response to the request issued by the data requester;
a position determiner that determines a position over the remote screen displayed on the display, which is specified by a user; and
a transmitter that transmits position data indicating the position determined by the position determiner, and the image data, to the information processing apparatus, and
   the information processing apparatus comprises:
a transmitter that transmits the screen data to the image processing apparatus;
a position calculator that calculates a position over the screen, corresponding to the position indicated by the position data received from the image processing apparatus; and
a controller that determines a destination to store the image data, based on what is displayed in the position calculated by the position calculator, and also stores the image data into the determined destination.

According to a second aspect of the present invention, an image processing system comprises an image processing apparatus and an information processing apparatus consisting of a personal computer, interconnected via a network, wherein:

the image processing apparatus comprises:
a reader that reads a document;
a transmitter that transmits to the information processing apparatus, image data read out from the document by the reader as well as a request for data of the available destination folders to transfer the image data, in a mode to transfer the image data to the information processing apparatus;
a display that displays on itself, a selection screen to allow a user to select a destination folder, based on the data of the available destination folders, which is transmitted by the information processing apparatus in response to the request for the data;
a replying portion that returns to the information processing apparatus, specified destination data indicating a destination folder that is specified among those listed in the selection screen displayed on the display, and
   the information processing apparatus comprises:
a character recognition processor that performs character recognition on the image data received from the image processing apparatus;
a detector that detects the available destination folders to transfer the image data, based on the data processed by character recognition;
a transmitter that transmits data of the detected available destination folders to the image processing apparatus; and
a controller that transfers the image data to a destination folder indicated by specified destination data received from the image processing apparatus.

According to a third aspect of the present invention, an image processing apparatus capable of being connected via a network to an information processing apparatus consisting of a personal computer, comprises:
a reader that reads a document;
a data requester that requests the information processing apparatus to allow to obtain screen data to reproduce a screen displayed on a display of the information processing apparatus, in a mode to transfer image data read out from the document, to the information processing apparatus;
a display that display on itself, a remote screen that is the image processing apparatus's screen reproduced based on the screen data that is transmitted by the information processing apparatus in response to the request issued by the data requester;
a position determiner that determines a position specified by a user via the remote screen displayed on the display; and
a transmitter that transmits position data indicating the position determined by the position determiner, and the image data, to the information processing apparatus.

According to a fourth aspect of the present invention, an image processing apparatus capable of being connected via a network to an information processing apparatus consisting of a personal computer, comprises:
a reader that reads a document;
a transmitter that transmits to the information processing apparatus, image data read out from the document by the reader as well as a request for data of the available destination folders to transfer the image data, in a mode to transfer the image data to the information processing apparatus;
a display that display on itself, a selection screen to allow a user to select a destination folder, based on the data of the available destination folders, which is transmitted by the information processing apparatus in response to the request for the data; and
a replying portion that returns to the information processing apparatus, specified destination data indicating a destination folder that is specified among those listed in the selection screen displayed on the display.

According to a fifth aspect of the present invention, an image data transfer method is executed between an image processing apparatus and an information processing apparatus consisting of a personal computer, interconnected via a network, wherein:

the image processing apparatus executes:
reading a document;
requesting the information processing apparatus to allow to obtain screen data to reproduce a screen displayed on a display of the information processing apparatus, in a mode to transfer image data read out from the document, to the information processing apparatus;
displaying on the display, a remote screen that is the information processing apparatus's screen reproduced based on the screen data that is transmitted by the information processing apparatus in response to the request;
determining a position over the remote screen displayed on the display, which is specified by a user; and
transmitting position data indicating the determined position and the image data, to the information processing apparatus, and
   the information processing apparatus executes:
transmitting the screen data to the image processing apparatus;
calculating a position over the screen, corresponding to the position indicated by the position data received from the image processing apparatus; and
determining a destination to store the image data, based on what is displayed in the calculated position, and also storing the image data into the determined destination.

According to a sixth aspect of the present invention, an image data transfer method is executed between an image processing apparatus and an information processing apparatus consisting of a personal computer, interconnected via a network, wherein:

the image processing apparatus executes:
reading a document;
transmitting to the information processing apparatus, image data read out from the document as well as a request for data of the available destination folders to transfer the image data, in a mode to transfer the image data to the information processing apparatus;
displaying on the display, a selection screen to allow a user to select a destination folder, based on the data of the available destination folders, which is transmitted by the information processing apparatus in response to the request for the data; and
returning to the information processing apparatus, specified destination data indicating a destination folder that is specified among those listed in the selection screen displayed on the display, and
   the information processing apparatus executes:
performing character recognition on the image data received from the image processing apparatus;
detecting the available destination folders to transfer the image data, based on the data processed by character recognition;
transmitting data of the detected destination folders to the image processing apparatus; and
transferring the image data to a destination folder indicated by specified destination data received from the image processing apparatus.

According to a seventh aspect of the present invention, a computer readable recording medium has an image data transfer program recorded therein to make a computer of an image processing apparatus execute:
reading a document;
requesting the information processing apparatus to allow to obtain screen data to reproduce a screen displayed on a display of the information processing apparatus, in a mode to transfer image data read out from the document, to the information processing apparatus;
displaying on a display, a remote screen that is the information processing apparatus's screen reproduced based on the screen data that is transmitted by the information processing apparatus in response to the request; determining a position over the remote screen displayed on the display, which is specified by a user; and
transmitting position data indicating the determined position and the image data, to the information processing apparatus.

According to a eighth aspect of the present invention, a computer readable recording medium has an image data transfer program recorded therein to make a computer of an image processing apparatus execute:
reading a document;
transmitting to the information processing apparatus, image data read out from the document as well as a request for data of the available destination folders to transfer the image data, in a mode to transfer the image data to the information processing apparatus;
displaying on a display, a selection screen to allow a user to select a destination folder, based on the data of the available destination folders, which is transmitted by the information processing apparatus in response to the request for the data; and
transmitting specified destination data indicating the destination folder that is specified among those listed in the selection screen displayed on the display.

### BRIEF DESCRIPTION OF THE DRAWINGS

FIG. 1 This is a view schematically showing a configuration of an image processing system according to one embodiment of the present invention.

FIG. 2 This is a block diagram schematically showing a configuration of an image processing apparatus.

FIG. 3 This is a block diagram schematically showing a configuration of an information processing apparatus.

FIG. 4 This is a view showing a screen displayed on a display of an operation panel, in which a “Scan to Desktop” button is shown.

FIG. 5 This is a view showing a next screen displayed on the display, when the “Scan to Desktop” button shown in the screen of FIG. 4, is pressed.

FIG. 6 This is a view to explain operations performed when a position over a window opened in the remote screen by an application, is specified.

FIG. 7 This is a view to explain operations performed when a position over the desktop screen displayed in the remote screen, is specified.

FIG. 8 This is a view to explain operations performed when a position over a window opened by e-mail software in the desktop screen displayed in the remote screen, is specified.

FIG. 9 This is a view to explain operations when a data discarding icon shown in the remote screen, is specified.

FIG. 10 This is a view to explain operations when an icon not holding folders shown in the remote screen, is specified.

FIG. 11 This is a view showing a screen displayed on the display of an operation panel, in which available destination folders are listed.

FIG. 12 This is a flowchart representing a procedure to transfer scan data, executed by a CPU of the image processing apparatus.

FIG. 13 This is a flowchart representing a subroutine that corresponds to a position data creation process in Step S10 of FIG. 12.

FIG. 14 This is a flowchart representing a transfer procedure executed in the information processing apparatus.

### MODE FOR CARRYING OUT THE INVENTION

Hereinafter, one embodiment of the present invention will be explained with reference to some Figures.

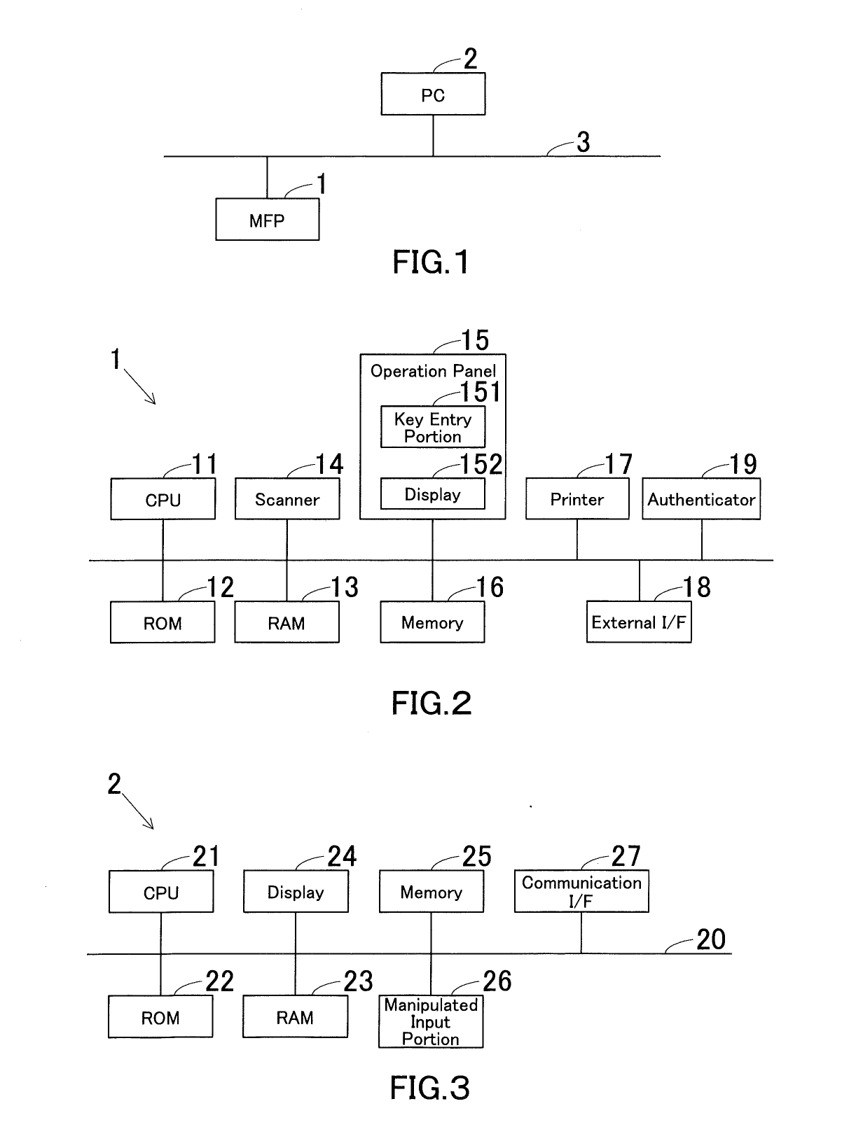

FIG. 1 is a view schematically showing a configuration of an image processing system according to one embodiment of the present invention.

As shown in FIG. 1, this image processing system includes a MFP 1 employed as an image processing apparatus that is a multifunctional digital image forming apparatus as described above, and an information processing apparatus (hereinafter, will be referred to as “PC”) 2 employed as a user terminal consisting of a personal computer. And the MFP 1 and the PC 2 are interconnected via a network 3 such as a LAN.

FIG. 2 is a block diagram schematically showing a configuration of the MFP 1.

As shown in FIG. 2, the MFP 1 includes a CPU 11, a ROM 12, a RAM 13, a scanner 14, an operation panel 15, a memory 16, a printer 17, an external interface (I/F) 18, an authenticator 19 and etc.

The CPU 11 centrally controls all operations of the MFP 1. Furthermore, in this embodiment, the CPU 11 requests the PC 2 to allow to obtain screen data to reproduce the PC 2's screen, and determines a position over a remote screen that is the PC 2's screen reproduced based on the screen data, when a user specifies that position. Detailed explanation thereof will be provided later.

The ROM 12 is a memory that stores in itself an operation program executed by the CPU 11. The RAM 13 is a memory that provides a working area for the CPU 11.

The scanner 14 reads an image on a document and converts it into image data that is an electronic signal.

The operation panel 15 includes an entry keys portion 151 having various keys such as a start key and numeric keys, and a display 152 consisting of a liquid crystal display with touch panel functionality, or etc.

The memory 16 consists of a recording medium such a hard disk drive (HDD), or etc., and stores in itself, image data read out from a document by the scanner 14 and other data. Furthermore, the memory 16 registers in itself, authentication information of the respective users, used for user authentication, and address information of the PCs 2 owned by the respective users.

The printer 17 prints out image data read out from a document by the scanner 14, document data received from the PC 2 and other data, according to a print instruction.

The external interface (I/F) 18 serves as a communicator that exchanges data with the PC 2 and other external apparatuses, via the network 3.

The authenticator 19 authenticates users trying to log in. Alternatively, an external authentication server collectively holding user authentication information may authenticate users trying to log in.

FIG. 3 is a block diagram schematically showing a configuration of the PC 2.

As shown in FIG. 3, the PC 2 includes a CPU 21, a ROM 22, a RAM 23, a display 24, a memory 25, an entry operation portion 26, a communication interface (communication I/F) 28 and etc., and these are interconnected via a system bus 20.

The CPU 21 centrally controls the entire PC 2 by executing a program recorded in the ROM 22. Furthermore, in this embodiment, the CPU 21 transmits to the MFP 1, screen data for the MFP 1 to reproduce the screen displayed on the display 24, in response to a request for the screen data, received from the MFP 1, and calculates a position over a screen displayed on the display 24, based on position data, when the position data is received from the MFP 1. Furthermore, the CPU 21 identifies what is displayed in the calculated position, determines a destination folder to store image data, based on what is displayed in that position, stores in the determined folder image data received from the MFP 1, and performs other operations. Detailed explanation thereof will be provided later.

The ROM 22 is a recording medium that stores in itself, a program executed by the CPU 21 and other data.

The RAM 23 is a recording medium that provides a working area for the CPU 21 to execute processing according to an operation program.

The display 24 consists of a CRT display, a liquid crystal display or etc., and displays on itself, the desktop screen based on an OS (Operating System: for example, a Windows (registered trademark) series by Microsoft Inc.) that is basic software, screens brought by various applications, and other screens.

The memory 25 consists of a recording medium such as a hard disk drive (HDD), and stores in itself various application programs and other data.

The entry operation portion 26 consists of a keyboard, a mouse and etc., and is used by users for entry operations.

The communication interface (communication I/F) 27 serves as a communicator that exchanges data with the MFP 1 and other external apparatuses, via the network 3.

Hereinafter, the method to store in the PC 2, image data (also referred to as “scan data”) read out from a document by the scanner 14 of the MFP 1, will be described.

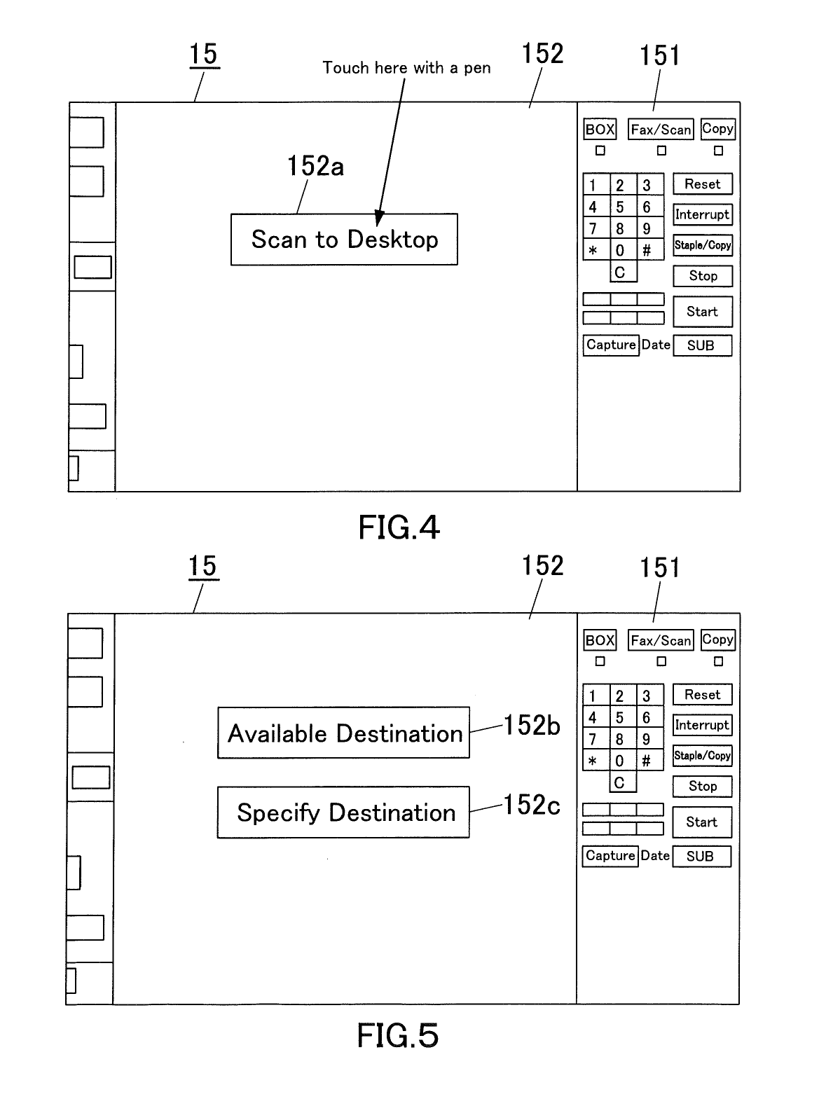

A user logs in the MFP 1 after being authenticated, and presses a mode key of the operation panel 15, not shown in Figure. Then, a “Scan to Desktop” button 152a is shown on the display 152 of the operation panel 15, as shown in FIG. 4. When the user presses the button 152a, the mode to transfer scan data to the PC 2 is employed, and the screen displayed on the display 152 is switched to a screen shown in FIG. 5. As shown in FIG. 5, an “Available Destination” button 152b and a “Specify Destination” button 152c are shown in the screen.

Meanwhile, the MFP 1 identifies a PC owned by this login user among the information of the PCs 2 owned by the respective users, which is registered in the memory 16, then connects to the PC 2.

The user presses the “Specify Destination” button 152c shown in the screen of FIG. 5. Then, the MFP 1 transmits to the PC 2, a request for screen data for the MFP 1 to reproduce a screen displayed on the display 24 of the PC 2.

In response to the request, the PC 2 transmits to the MFP 1 screen data of the screen currently displayed on the display 24.

The MFP 1 displays on the display 152 of the operation panel 15, a remote screen that is the PC 2's screen reproduced based on the screen data received therefrom.

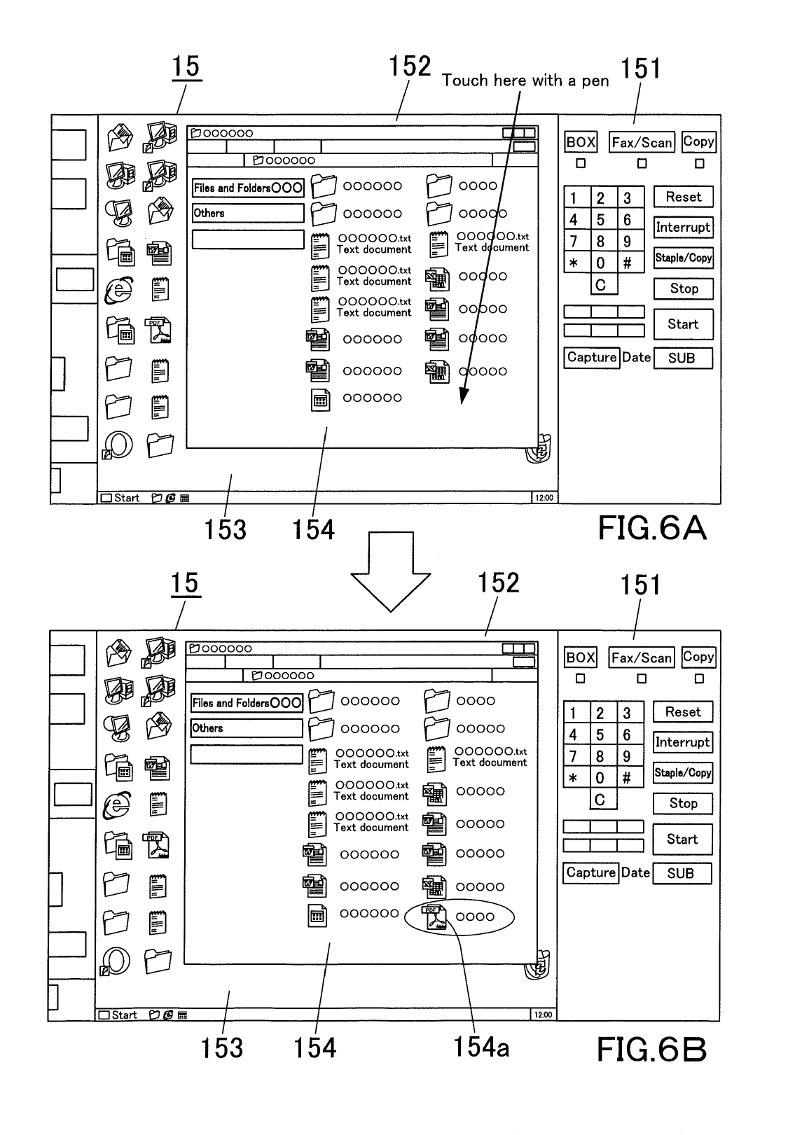

FIG. 6 (A) is a view showing a remote screen displayed on the display 152 of the operation panel 15. In this example, a window is opened by a predetermined application, in the desktop screen displayed on the display 24 of the PC2. Accordingly, a remote screen that is a desktop screen 153 including the window 154 opened by the application, is displayed on the display 152 of the operation panel 15 of the MFP 1.

As indicated by an arrow here, a user specifies a position over the window 154 by using a predetermined entry pen. Then, the specified position (the touched position) over the remote screen is determined and position data indicating the determined position is transmitted to the PC 2.

Receiving the position data indicating the determined position, the PC 2 calculates a position over the screen displayed on the display 24, corresponding to the position indicated by the position data.

Meanwhile, the MFP 1 transmits scan data obtained by the scanner 14. The PC 2 identifies what is displayed in the calculated position, and determines a folder to store the scan data based on what is displayed in that position, and then stores the scan data in the folder. In other words, as if data has been dragged and dropped inside the PC 2, the scan data is stored in a folder determined based on what is displayed in the calculated position, and also a file icon representing the scan data is displayed in the calculated position.

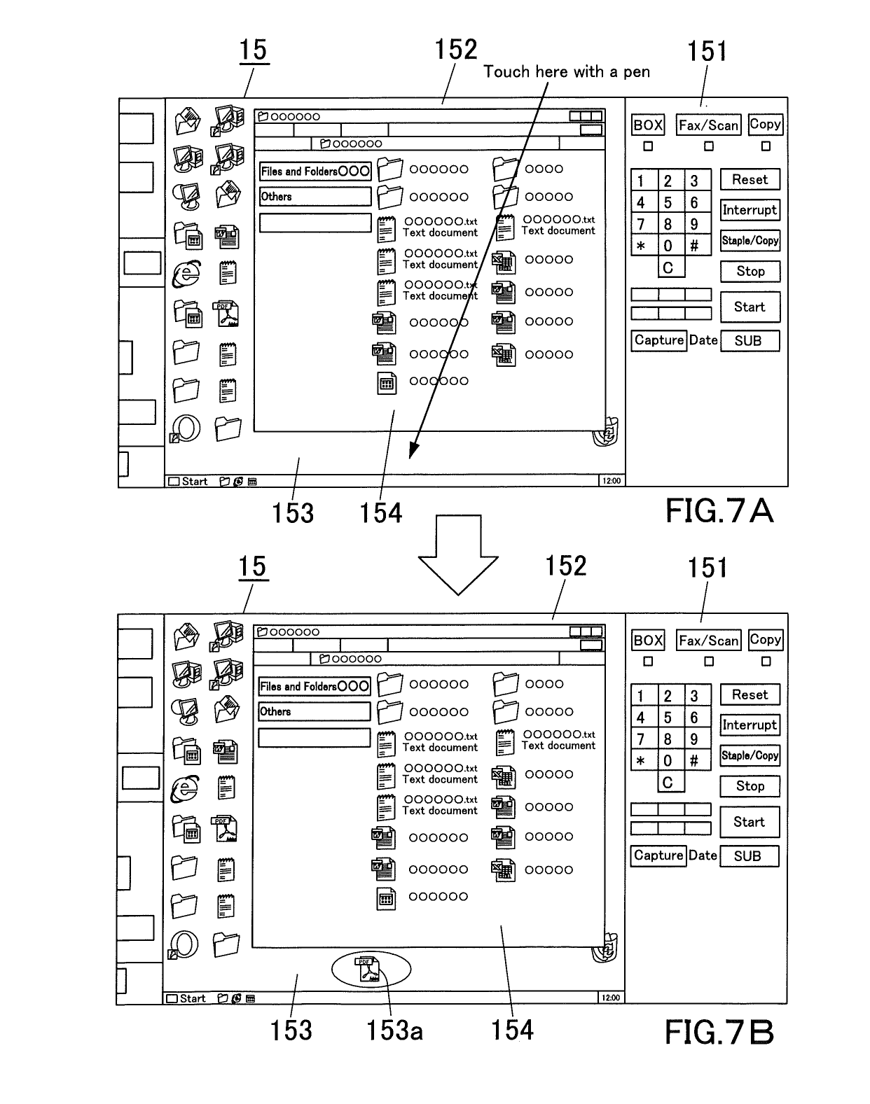

In an example of FIG. 6 (A), a user specifies a position over the window 154 opened by an application in the remote screen. Then, as shown in FIG. 6 (B), the PC 2 stores the scan data into a folder related to the application, and also provides a file icon 154a representing the scan data in the window 154. FIG. 6 (B) shows a remote screen displayed on the 152 of the MFP 1, in which a file icon representing the scan data is provided in a window displayed on the display 24 of the PC 2. Similarly, FIG. 7 (B) through FIG. 9 (B) to be explained hereinafter also show such a remote screen.

If a position over the desktop screen 153 displayed in the remote screen is specified as a transfer destination as shown in FIG. 7 (A), the PC 2 stores the scan data into a folder determined based on what is displayed in the specified position over the desktop screen 153 as shown in FIG. 7 (B). In this case, the scan data is stored into the desktop folder. And also, a file icon 153a is provided in the specified (calculated) position.

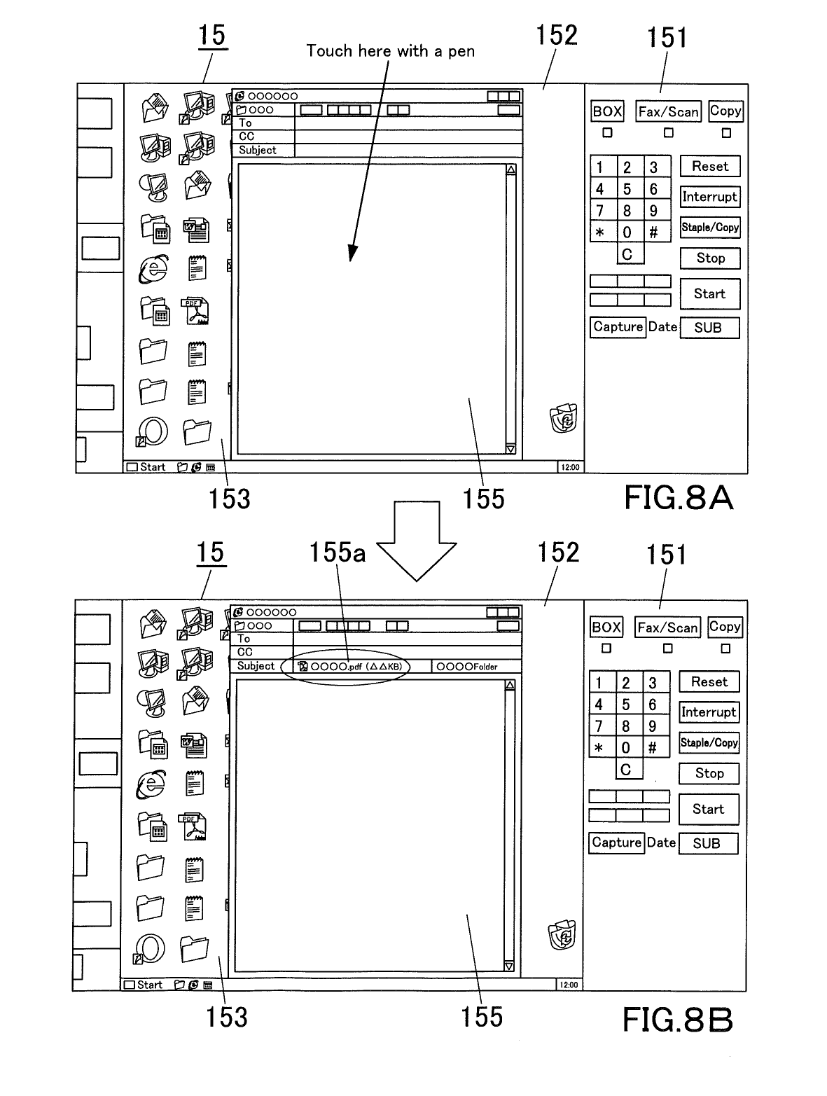

If a position over a window 155 opened by e-mail software in the desktop screen 153 displayed on the remote screen, as shown in FIG. 8 (A), the scan data is stored into a folder related to the e-mail software and the scan data is set as an attachment file 155a as shown in FIG. 8 (B).

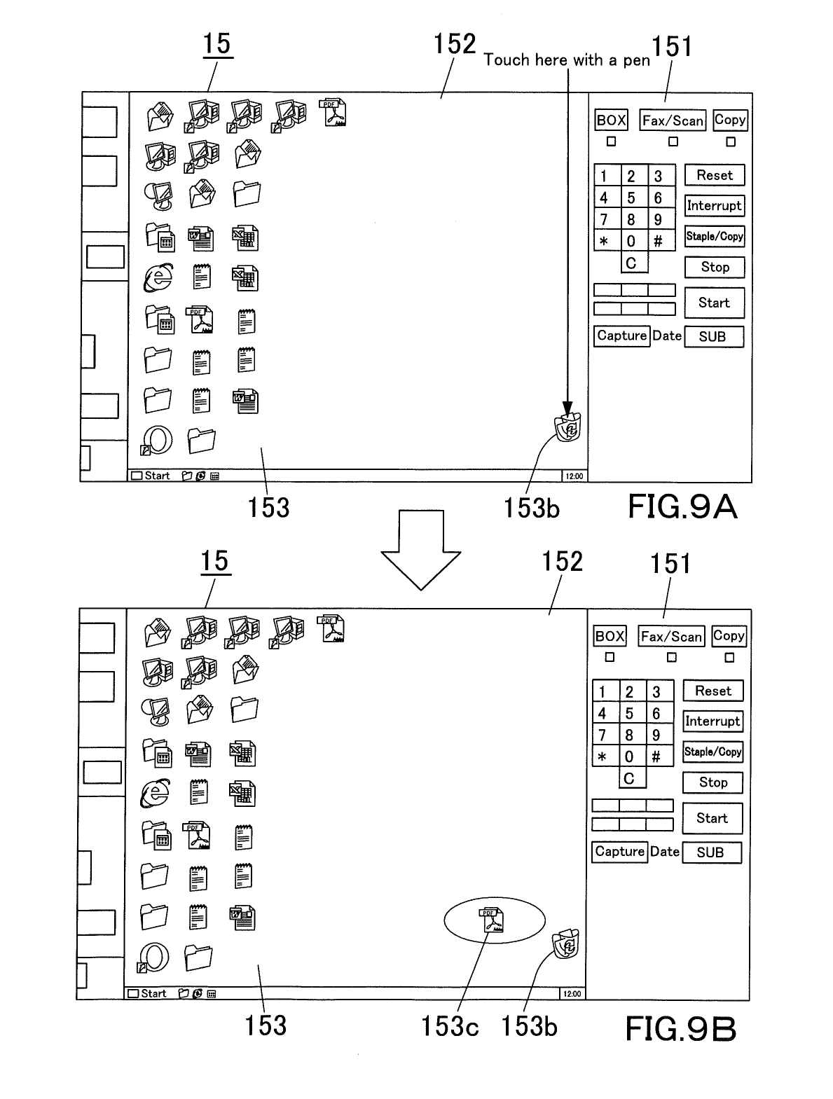

If a position calculated by the PC 2 is overlapped with an data discarding icon (so-called “trash box”) 153b shown in the desktop screen 153 as shown in FIG. 9 (A), in other words, when a user specifies the data discarding icon 153b shown in the remote screen, the scan data is not stored into a folder related to the data discarding icon 153b, but is stored into a folder positioned in the vicinity of the data discarding icon 153b, and a file icon representing the scan data is provided in the vicinity thereof. Accordingly, as shown in FIG. 9 (B), a file icon 153c representing the scan data is provided in the vicinity of the data discarding icon 153b, and the scan data is stored into the desktop folder. Thus, even if a user carelessly happens to specify the data discarding icon 153b, the scan data would not be discarded, which is convenient.

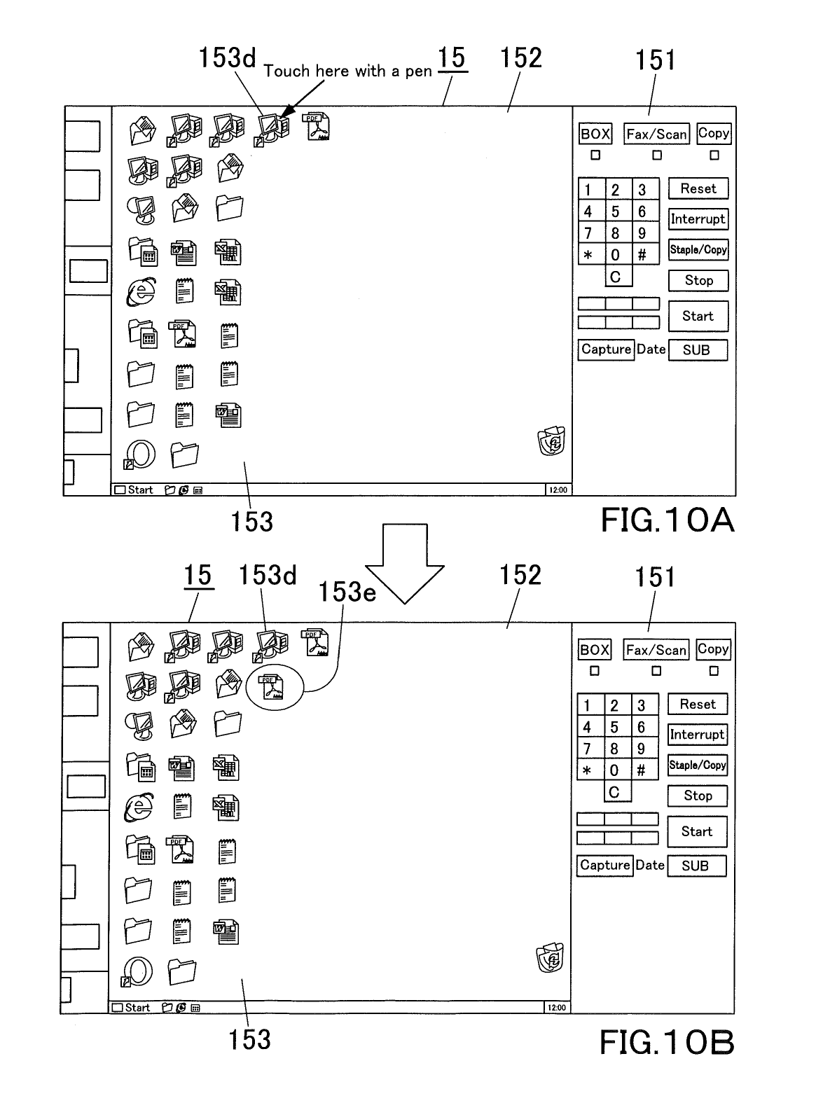

If a position calculated by the PC 2 is overlapped with an icon not holding folders (for example “my computer” icon) 153d shown in the desktop screen 153, as shown in FIG. 10 (A), in other words, when a user specifies an icon not holding folders 153d shown in the remote screen, the scan data is stored into a folder positioned in the vicinity of the icon 153d, and a file icon representing the scan data is provided in the vicinity thereof. Accordingly, as shown in FIG. 10 (B), a file icon 153e representing the scan data is provided in the vicinity of the icon 153d, and the scan data is stored into the desktop folder.

Meanwhile, if a position calculated by the PC 2 is overlapped with a file folder icon shown in the desktop screen 153, in other words, if a user specifies a file folder icon shown in the remote screen, the scan data is stored into a folder represented by the file folder icon.

As described above, when a user simply specifies a position (transfer destination) over a remote screen displayed on the display 152 of the operation panel 15 of the MFP 1, scan data is stored into a folder determined based on what is displayed in the corresponding position over the PC 2's screen. And thus, available destination folders are not limited, and manual entry of a path to specify a destination folder is not required. Furthermore, users are allowed to store image data into a preferable folder, simply by specifying a position over the remote screen, as if directly operating a screen displayed on the display 24 of the PC 2, which would be extremely advantageous.

Hereinafter, operations performed when the “Available Destination” button 152b shown in the screen of FIG. 5, is pressed.

When the “Available Destination” button 152b is pressed, the MFP 1 transmits to the PC 2, a request for data of the available destination folders to transfer scan data, and further transmits thereto the scan data. The scan data is temporarily stored into the memory 25.

Receiving the request and the scan data, the PC 2 performs character recognition on the scan data; extracts a keyword therefrom; detects icons related to the keyword or strongly related to the keyword among the icons shown in the desktop screen; and returns to the MFP 1, a list of the folder names and/or the file names of the detected icons, as data of the available destination folders. The keyword may be a string of large characters such as a headline, property information or etc.

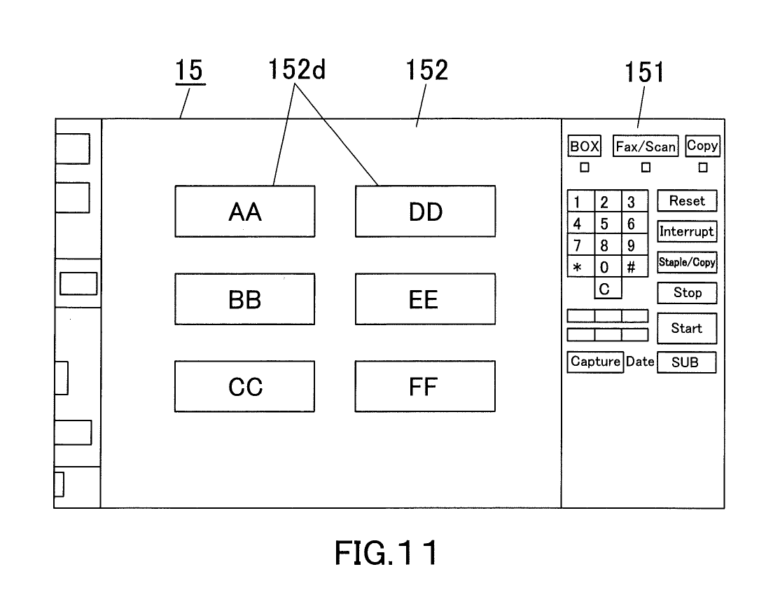

Receiving the data of the available destination folders, the MFP 1 displays the available destination folders 152d on the display 152 of the operation panel 15, as shown in FIG. 11.

When a user specifies a preferable destination folder among those displayed thereon, specified destination data indicating the specified destination folder is transmitted to the PC2.

If the specified destination data is a folder name of the icon, the PC 2 having received the specified destination data, transfers the scan data to the folder having that folder name. Meanwhile, if it is a file name, it transfers the scan data to a folder holding the file having that file name.

As described above, when the “Available Destination” button 152b is pressed, the available destination folders 152d are listed on the display 152, based on data of the available destination folders, received from the PC 2. And when a user simply specifies a preferable destination folder among the available destination folders, scan data is automatically transferred and stored into the destination folder. And thus, available destination folders are not limited, and manual entry of a path to specify a destination folder is not required. Furthermore, users are allowed to transfer scan data to a preferable destination folder among the available destination folders. That could improve usability of the image processing system.

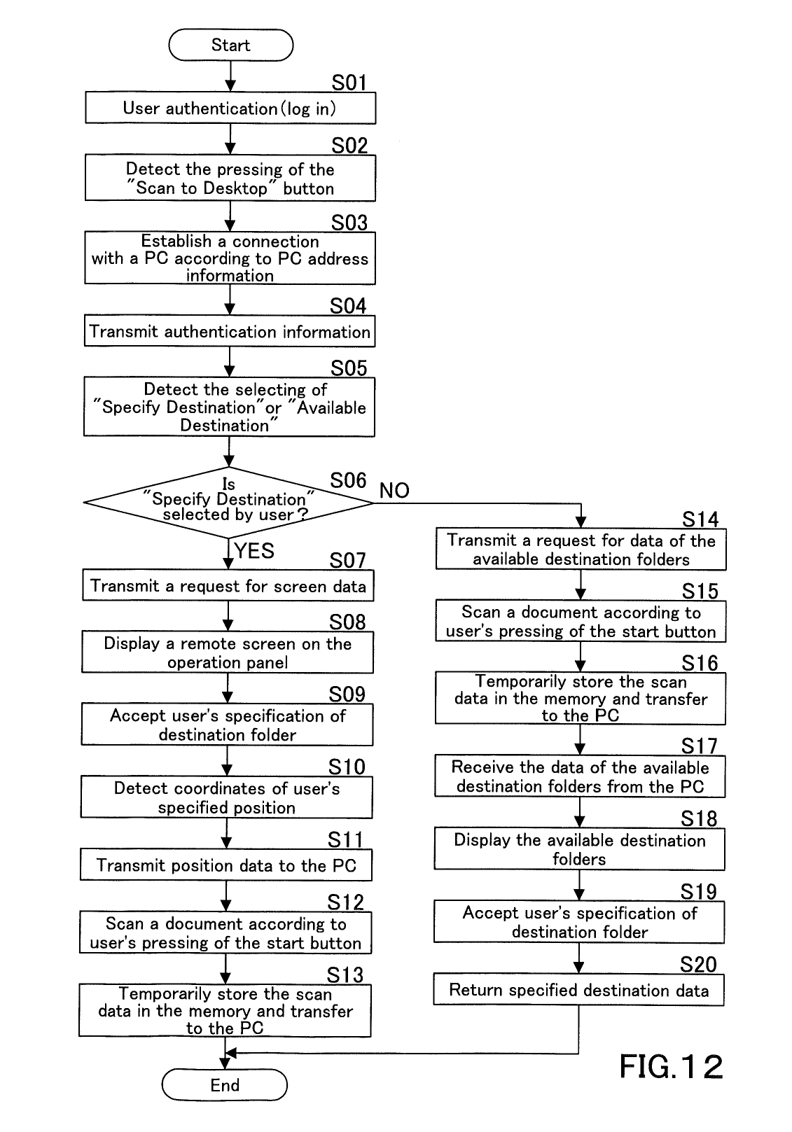

FIG. 12 is a flowchart representing a procedure to transfer scan data as described above, executed by the CPU 11 of the MFP 1. This procedure is executed by the CPU 11 of the MFP 1 according to an operation program recorded in a recording medium such as the ROM 12.

User authentication is performed in Step S01, and the pressing of the “Scan to Desktop” button is detected in Step S02. Then, a connection with the PC 2 operated by the login user is established according to PC address information recorded in the memory 16, in Step S03. And authentication information of the user is transmitted to the PC 2 in Step S04. Based on the authentication information received therefrom, the PC 2 performs user authentication to check if the PC 2 is owned by the user logged on the MFP 1.

Then, the pressing of the “Specify Destination” button 152c or the “Available Destination” button 152b is detected in Step S05, and it is judged in Step S06, whether or not the “Specify Destination” button 152c is pressed by the user.

If the “Specify Destination” button 152c is pressed (YES in Step S06), a request for screen data is transmitted to the PC 2 in Step S07.

And in Step S08, a remote screen is displayed on the display 152 of the operation panel 15, based on the screen data received from the PC 2.

The user specifies a destination to transfer scan data, via the remote screen displayed thereon. Then, this is accepted in Step S09, and coordinates of the position specified by the user are detected and position data is created in Step S10. After that, the created position data is transmitted to the PC 2 in Step S11.

Subsequently, the user places a document on the scanner 14 and presses a start button. Then, this is detected and scan data is obtained by reading the document, in Step S12. And the scan data is temporarily stored in the memory 16 and transferred to the PC 2, in Step S13.

Receiving the scan data, the PC 2 stores the scan data into a folder that is determined based on what is displayed in the position specified by the user.

Meanwhile in Step 506, if the “Available Destination” button 126b is pressed (NO in Step S06), a request for data of the available transfer destinations, is transmitted to the PC 2, in Step S14.

Subsequently, the user places a document on the scanner 14 and presses a start button. Then, this is detected and scan data is obtained by reading the document, in Step S15. And the scan data is temporarily stored in the memory 16 and transferred to the PC 2, in Step S16.

The PC 2 performs character recognition on the received scan data; extracts a keyword therefrom; detects available destination folders by the keyword; and returns data of the available destination folders to the MFP 1.

In Step S17, the data of the available destination folders is received by the MFP 1 from the PC 2. And in Step S18, the available destination folders 152d are listed on the display 152 of the operation panel 15. When the user specifies a destination folder, this is accepted in Step S19, and specified destination data indicating the specified destination folder is transmitted to the PC 2 in Step S20.

Receiving the specified destination data, the PC 2 stores the scan data received in advance, in the specified destination folder.

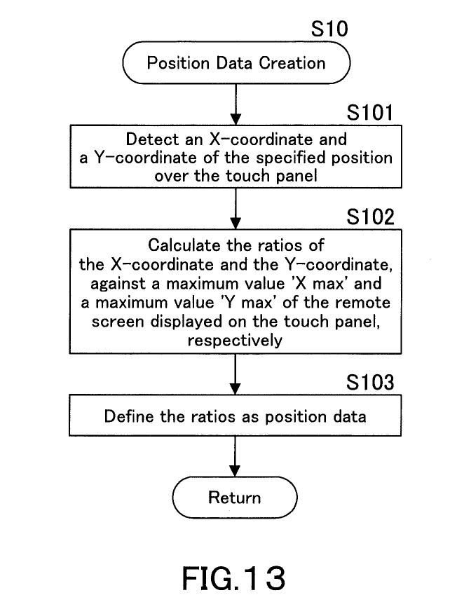

FIG. 13 is a flowchart representing a subroutine that is a position data creation process in Step S10 of FIG. 12.

In Step S101, an X-coordinate and a Y-coordinate of the position over the display (touch panel) 152 of the operation panel 15, specified by the user, are detected.

In Step S102, [X/X max] and [Y/Y max], which are the ratios of a value X of the detected X-coordinate and a value Y of the detected Y-coordinate against a maximum value ‘X max’ of the X-coordinate and a maximum value ‘Y max’ of the Y-coordinate, of the remote screen displayed on the display (touch panel) 152, respectively, are calculated. And the calculated ratios are defined as position data in Step S103. After that, the subroutine returns.

Concretely, the specified position over the remote screen displayed on the display (touch panel) 152, is determined by calculating the ratios of X-coordinates and Y-coordinates. The specified position over the remote screen corresponds to a position over the screen displayed on the display 24 of the PC 2, represented by the ratio of the values X and Y against the maximum values ‘X max’ of the X-coordinate and the maximum value ‘Y max’ of the Y-coordinate. In this way, a position over the screen displayed on the display 24, corresponding to the specified position over the remote screen, can be calculated easily and accurately.

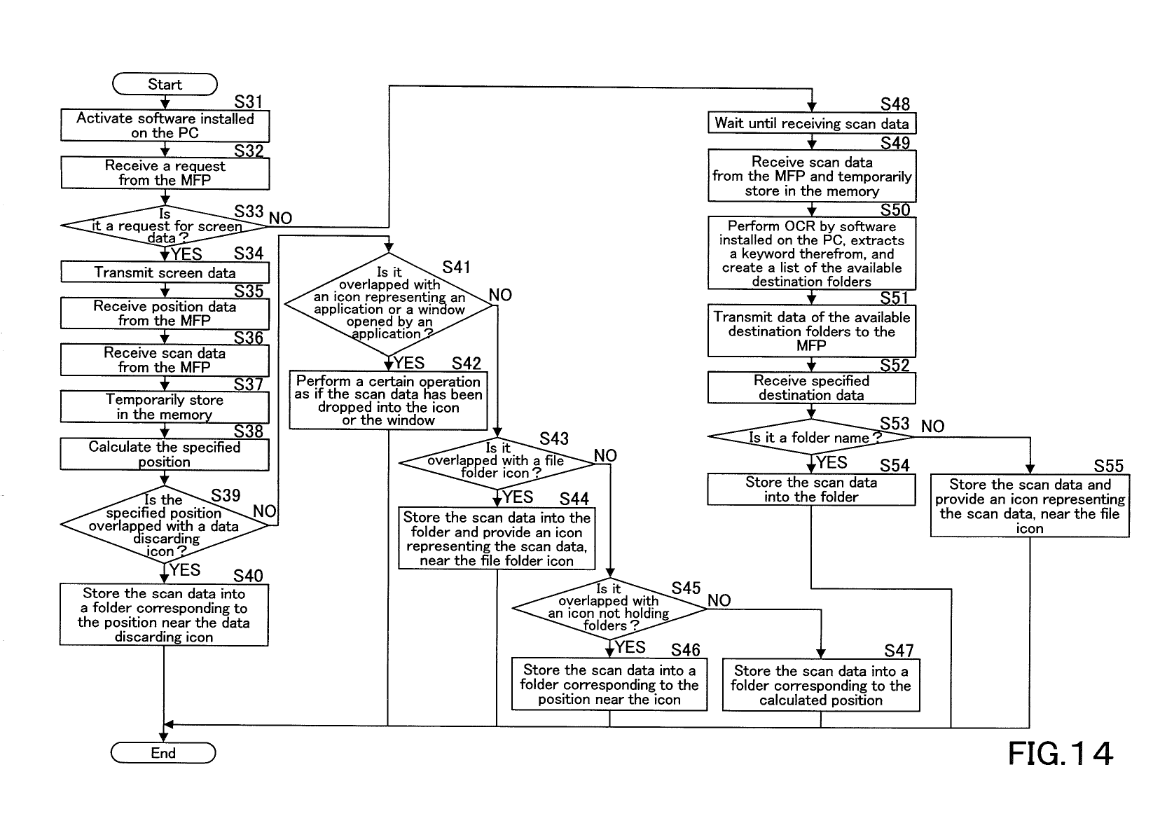

FIG. 14 is a flowchart representing a transfer procedure executed in the PC 2. This procedure is executed by the CPU 21 of the PC 2 according to an operation program recorded in a recording medium such as the ROM 22.

Software installed on the PC 2 is activated in Step S31, and a request for screen data or data of the available destination folders is received from the MFP 1 in Step S32. Then it is judged in Step S23, whether or not it is a request for screen data.

If it is a request for screen data (YES in Step S33), the mode is switched to the remote desktop mode, and in Step S34, screen data is transmitted to the MFP 1.

In Step S35, position data indicating a position over the remote screen, specified by the user, is received from the MFP 1 in Step S35, and scan data is received from the MFP 1 in Step S36. Then, the received scan data and other data are temporarily stored in the memory 25 in Step S37.

Then in Step S38, a position over the desktop screen displayed on the display 24, corresponding to the specified position, is calculated based on the position data.

In Step S39, it is judged whether or not the calculated position is overlapped with a data discarding icon (trash box) shown in the desktop screen. If it is overlapped therewith (YES in Step S39), then in Step S40, the scan data is stored into the desktop folder, not into the data discarding icon, and a file icon representing the scan data is provided in the vicinity of the data discarding icon.

Meanwhile in Step S39, if the calculated position is not overlapped with a data discarding icon (NO in Step S39), then it is judged in Step S41, whether or not it is overlapped with an icon representing an application or a window opened by an application.

If it is overlapped with an icon representing an application or a window opened by an application (YES in Step S41), a certain operation is performed as if the scan data is dragged and dropped into the icon or the window, in Step S42.

If it is not overlapped with an icon representing an application or a window opened by an application (NO in Step S41), then it is judged in Step S43, whether or not it is overlapped with a file folder icon.

If it is overlapped with a file folder icon (YES in Step S43), then in Step S44, the scan data is stored into a folder represented by the file folder icon, and a file icon representing the scan data is provided in the vicinity of the file folder icon.

If it is not overlapped with a file folder icon (NO in Step S43), then it is judged in Step S45, whether or not the calculated position is overlapped with an icon not holding folders.

If it is overlapped therewith (YES in Step S45), then in Step S46, the scan data is stored into the desktop folder and a file icon representing the scan data is provided in the vicinity of the icon.

If it is not overlapped with an icon not holding folders (NO in Step S45), the scan data is stored into a folder corresponding to the position, in Step S47. In other words, the scan data is stored into the desktop folder and a file icon representing the scan data is provided in the position.

Meanwhile in Step S33, if it is judged that a request for data of the available destination folders is received from the MFP 1 (NO in Step S33), the routine proceeds to Step S48.

In Step S48, the routine waits until scan data is received from the MFP 1. The MFP 1 transmits scan data, then in Step S49, the scan data is received and temporarily stored into the memory 25.

In Step S50, character recognition is performed on the scan data by software for character recognition; a keyword is extracted therefrom; folder icons or file icons related to the keyword are detected among those displayed in the desktop screen; the folder names or file names of the icons are detected as the available destination folders, and listed.

Then in Step S51, the data of the available destination folders is transmitted to the MFP 1.

The MFP 1 transmits specified destination data, then in Step S52, the specified destination data is received. In Step S53, it is judged whether or not the specified destination data is a folder name. If it is a folder name (YES in Step S53), the scan data recorded in the memory 25 is stored into the folder having that folder name in Step S54.

If the specified destination data is a file name (NO in Step S53), then in Step S55, the scan data is transferred and stored into a folder holding the file having the file name, and a file icon representing the scan data is provided in the vicinity of the file icon having the file name.

This application claims priority to Japanese Patent Application No. 2008-241817 filed on Sep. 19, 2008, the entire disclosure of which is incorporated herein by reference in its entirety.

The terms and expressions provided herein have been employed for the purpose of explaining, never for the purpose of limiting interpretation or eliminating any equivalents of the characteristic objects illustrated or described herein. It should be understood that various other modifications can be made within the range of what the present invention claims.

### DESCRIPTION OF THE CODES

1 MFP (Image Processing Apparatus)
2 Information Processing Apparatus
3 Network
11 CPU
12 ROM
14 Scanner
15 Operation Panel
16 Memory
17 Printer
152 Display
21 CPU
24 Display
25 Memory

1. An image processing system comprising an image processing apparatus and an information processing apparatus consisting of a personal computer, interconnected via a network, wherein:
the image processing apparatus comprises:
a reader that reads a document;
a data requester that requests the information processing apparatus to allow to obtain screen data to reproduce a screen displayed on a display of the information processing apparatus, in a mode to transfer image data read out from the document, to the information processing apparatus;
a display that displays on itself, a remote screen that is the image processing apparatus's screen reproduced based on the screen data that is transmitted by the information processing apparatus in response to the request issued by the data requester;
a position determiner that determines a position over the remote screen displayed on the display, which is specified by a user; and
a transmitter that transmits position data indicating the position determined by the position determiner, and the image data, to the information processing apparatus, and
the information processing apparatus comprises:
a transmitter that transmits the screen data to the image processing apparatus;
a position calculator that calculates a position over the screen, corresponding to the position indicated by the position data received from the image processing apparatus; and
a controller that determines a destination to store the image data, based on what is displayed in the position calculated by the position calculator, and also stores the image data into the determined destination.

2. The image processing system recited in claim 1, wherein:
the image processing apparatus's screen is the desktop screen; and
the controller stores the image data into the destination determined based on what is displayed in the calculated position over the desktop screen.

3. The image processing system recited in claim 1, wherein:
the controller provides a file icon representing the image data, in the position over the information processing apparatus's screen, which is calculated by the position calculator.

4. The image processing system recited in claim 1, wherein:
the display of the image processing apparatus consists of a touch-panel display; and
the position determiner determines the position specified by the user, based on coordinate values of the ordinate and the abscissa of the touch-panel display, which represent the specified position, and the maximum values of the ordinate and the abscissa of the remote screen displayed on the touch-panel display.

5. The image processing system recited in claim 1, wherein:
if the position over the screen, calculated by the position calculator of the information processing apparatus, is overlapped with a file folder icon displayed in the screen, the controller stores the image data into a folder represented by the file folder icon.

6. The image processing system recited in claim 5, wherein:
the controller provides a file icon representing the image data, in the vicinity of the file folder icon.

7. The image processing system recited in claim 1, wherein:
if the position over the screen, calculated by the position calculator of the information processing apparatus, is overlapped with an icon representing an application, displayed in the screen, or a window screen opened by an application, displayed in the screen, the controller performs a certain operation as if the image data has been dragged and dropped into the icon representing an application or the window screen opened by an application.

8. The image processing system recited in claim 1, wherein:
if the position over the screen, calculated by the position calculator of the information processing apparatus, is overlapped with a data discarding icon displayed in the screen, the controller stores the image data into a destination determined based on what is displayed in the vicinity of the data discarding icon.

9. The image processing system recited in claim 8, wherein:
the controller provides a file icon representing the image data, in the vicinity of the data discarding icon.

10. The image processing system recited in claim 1, wherein:
if the position over the screen, calculated by the position calculator of the information processing apparatus, is overlapped with an icon not holding folders, displayed in the screen, the controller stores the image data into a destination determined based on what is displayed in the vicinity of the icon not holding folders.

11. The image processing system recited in claim 10, wherein:
the controller provides a file icon representing the image data, in the vicinity of the icon not holding folders.

12. An image processing system comprising an image processing apparatus and an information processing apparatus consisting of a personal computer, interconnected via a network, wherein:
the image processing apparatus comprises:
a reader that reads a document;
a transmitter that transmits to the information processing apparatus, image data read out from the document by the reader as well as a request for data of the available destination folders to transfer the image data, in a mode to transfer the image data to the information processing apparatus;
a display that displays on itself, a selection screen to allow a user to select a destination folder, based on the data of the available destination folders, which is transmitted by the information processing apparatus in response to the request for the data;
a replying portion that returns to the information processing apparatus, specified destination data indicating a destination folder that is specified among those listed in the selection screen displayed on the display, and
the information processing apparatus comprises:
a character recognition processor that performs character recognition on the image data received from the image processing apparatus;
a detector that detects the available destination folders to transfer the image data, based on the data processed by character recognition;
a transmitter that transmits data of the detected available destination folders to the image processing apparatus; and
a controller that transfers the image data to a destination folder indicated by specified destination data received from the image processing apparatus.

13. The image processing system recited in claim 12, wherein:
the detector of the information processing apparatus extracts a keyword from the data processed by character recognition, and further detects folder icons and/or file icons related to the extracted keyword, among those displayed on the information processing apparatus;
the transmitter transmits to the image processing apparatus, the folder names and/or file names of the detected folder icons and/or file icons, as the data of the available destination folders; and
the controller transfers the image data to a folder having a certain folder name, if the specified destination data received from the image processing apparatus is that folder name, meanwhile transfers the image data to a folder holding a file having a certain file name, if the specified destination data received from the image processing apparatus is that file name.

14. An image processing apparatus capable of being connected via a network to an information processing apparatus consisting of a personal computer, comprising:
a reader that reads a document;
a data requester that requests the information processing apparatus to allow to obtain screen data to reproduce a screen displayed on a display of the information processing apparatus, in a mode to transfer image data read out from the document, to the information processing apparatus;
a display that display on itself, a remote screen that is the image processing apparatus's screen reproduced based on the screen data that is transmitted by the information processing apparatus in response to the request issued by the data requester;
a position determiner that determines a position specified by a user via the remote screen displayed on the display; and
a transmitter that transmits position data indicating the position determined by the position determiner, and the image data, to the information processing apparatus.

15. The image processing apparatus recited in claim 14, wherein:
the screen data that is transmitted by the information processing apparatus in response to the request issued by the data requester, serves to reproduce the desktop screen of the information processing apparatus.

16. The image processing apparatus recited in claim 14, wherein:
the display consists of a touch-panel display; and
the position determiner determines the position specified by the user, based on coordinate values of the ordinate and the abscissa of the touch-panel display, which represent the specified position, and the maximum values of the ordinate and the abscissa of the remote screen displayed on the touch-panel display.

17. An image processing apparatus capable of being connected via a network to an information processing apparatus consisting of a personal computer, comprising:
a reader that reads a document;
a transmitter that transmits to the information processing apparatus, image data read out from the document by the reader as well as a request for data of the available destination folders to transfer the image data, in a mode to transfer the image data to the information processing apparatus;
a display that display on itself, a selection screen to allow a user to select a destination folder, based on the data of the available destination folders, which is transmitted by the information processing apparatus in response to the request for the data; and
a replying portion that returns to the information processing apparatus, specified destination data indicating a destination folder that is specified among those listed in the selection screen displayed on the display.

18. An image data transfer method executed between an image processing apparatus and an information processing apparatus consisting of a personal computer, interconnected via a network, wherein:
the image processing apparatus executes:
reading a document;
requesting the information processing apparatus to allow to obtain screen data to reproduce a screen displayed on a display of the information processing apparatus, in a mode to transfer image data read out from the document, to the information processing apparatus;
displaying on the display, a remote screen that is the information processing apparatus's screen reproduced based on the screen data that is transmitted by the information processing apparatus in response to the request;
determining a position over the remote screen displayed on the display, which is specified by a user; and
transmitting position data indicating the determined position and the image data, to the information processing apparatus, and
the information processing apparatus executes:
transmitting the screen data to the image processing apparatus;
calculating a position over the screen, corresponding to the position indicated by the position data received from the image processing apparatus; and
determining a destination to store the image data, based on what is displayed in the calculated position, and also storing the image data into the determined destination.

19. An image data transfer method executed between an image processing apparatus and an information processing apparatus consisting of a personal computer, interconnected via a network, wherein:
the image processing apparatus executes:
reading a document;
transmitting to the information processing apparatus, image data read out from the document as well as a request for data of the available destination folders to transfer the image data, in a mode to transfer the image data to the information processing apparatus;
displaying on the display, a selection screen to allow a user to select a destination folder, based on the data of the available destination folders, which is transmitted by the information processing apparatus in response to the request for the data; and
returning to the information processing apparatus, specified destination data indicating a destination folder that is specified among those listed in the selection screen displayed on the display, and
the information processing apparatus executes:
performing character recognition on the image data received from the image processing apparatus;
detecting the available destination folders to transfer the image data, based on the data processed by character recognition;
transmitting data of the detected destination folders to the image processing apparatus; and
transferring the image data to a destination folder indicated by specified destination data received from the image processing apparatus.

20. A computer readable recording medium having an image data transfer program recorded therein to make a computer of an image processing apparatus execute:
reading a document;
requesting the information processing apparatus to allow to obtain screen data to reproduce a screen displayed on a display of the information processing apparatus, in a mode to transfer image data read out from the document, to the information processing apparatus;
displaying on a display, a remote screen that is the information processing apparatus's screen reproduced based on the screen data that is transmitted by the information processing apparatus in response to the request;
determining a position over the remote screen displayed on the display, which is specified by a user; and
transmitting position data indicating the determined position and the image data, to the information processing apparatus.

21. A computer readable recording medium having an image data transfer program recorded therein to make a computer of an image processing apparatus execute:
reading a document;
transmitting to the information processing apparatus, image data read out from the document as well as a request for data of the available destination folders to transfer the image data, in a mode to transfer the image data to the information processing apparatus;
displaying on a display, a selection screen to allow a user to select a destination folder, based on the data of the available destination folders, which is transmitted by the information processing apparatus in response to the request for the data; and
transmitting specified destination data indicating the destination folder that is specified among those listed in the selection screen displayed on the display.
